(19) United States
(12) Patent Application Publication
(10) Pub. No.: US 2011/0297660 A1
(43) Pub. Date: Dec. 8, 2011

(54) HEATING DEVICE

(75) Inventor: Daniel Fritz, Stuttgart (DE)

(73) Assignee: SMR Patents S.a.r.l., Luxembourg (LU)

(21) Appl. No.: 13/154,961

(22) Filed: Jun. 7, 2011

(30) Foreign Application Priority Data
Jun. 7, 2010 (EP) 10165071.1

(51) Int. Cl. B60L 1/02

(52) U.S. Cl. 219/202

(57) ABSTRACT

A heating system for an exterior rear view minor is proposed, with which a defrost characteristic is achieved by suitable arrangement of heating regions, which leads to the representation of a logo during defrosting.

The invention is based on a priority patent application EP10165071.1 which is hereby incorporated by reference.

### BACKGROUND ART

1. Field of the Invention

The invention relates to a heating device for a mirror glass of a minor, particularly an exterior minor for a motor vehicle, whereby a heating installation is applied on a substrate, as well as a process for production of a minor of this type.

2. Description of the Related Art

In EP 0 732 865 B1, a heating device is known, which is formed by carbon fibres, which are conductively connected to each other by a binding agent. A mirror glass is applied on a backing plate for the minor glass by a bonding layer.

Furthermore, it is known to directly apply a heating installation on the rear side on the minor glass of a minor by a screen printing method or similar. As disclosed in FR 2 628 041, however, the reflective layer is then installed on the minor on the external side, with increased risk of damage to the reflective layer. In addition, in the known process, the conductive paste is fired at a temperature of approximately 670° , which can cause problems in maintenance of bending accuracy in spherical and aspherical minor glasses.

Alongside, it is also known from DE 10 2004 002 979 A1 to design the rear sided reflective layer on a minor glass directly as a heating layer.

However, in the process, problems occur in equal distribution of the current flow in the thin reflective layer, as well as in carrying out contacting.

DE 42 23 590 A1 shows a minor, in which a transparent heating device is attached as an ITO layer on the front side of the mirror glass, which is covered by a protective layer, which is applied by sputtering or by plasma deposition, for example. In this arrangement, the known problems exist in the contacting of thin layers. Additionally, the ITO layer is very sensitive to damages, which can lead to local ‘hot spots’.

Furthermore, FR 2 618 396 A1 describes a backing foil for a mirror glass, with a heating device applied by screen printing. On the front side of the heating device turned towards the mirror glass, a secure connection between the mirror glass and backing foil is produced by double-sided tape. In addition, the heating device is sealed through this.

Furthermore it is known, in general, to produce resistance heating for a minor glass in the form of a laminated copper foil in a photo etching process, and, subsequently, to attach the copper foil onto the backing plate with double-sided tape.

It is common to the whole prior art that equal heating should be achieved over the whole minor glass. Hot spots should be avoided in the process, and, of course, current peaks in the heating cables, in order to avoid a burn-out of the heating cables or evaporation of the heating layer.

U.S. Pat. No. 5,610,756 concerns minor heating for an electrochromatic minor. In order to optimally operate this mirror, two different modes are provided for the heating installation. A first state quickly heats a core area, in order to defrost the minor. In the second mode, the whole surface is heated, in order to guarantee an optimal operating temperature for the electrochemical process.

The EP0112930 shows a heatable rear window with a filament, which runs in the form of a logo.

U.S. Pat. No. 4,251,316 shows a heatable exterior mirror, in which a logo is formed in one surface insulated against the heating.

### SUMMARY OF THE INVENTION

The object of the invention is to provide a heating device for a minor glass of a mirror, in particular, an exterior minor of a motor vehicle, which provides an uneven heating output, contrary to the prior art, and therefore facilitates the appearance of a sign or logo e.g. the logo of the manufacturer of the vehicle during the defrosting process.

This object is achieved by a heating device with the features to distribute the surface to be heated in at least two regions, and to load the at least two regions with different heating output or a different temporal heat release.

In the process, the production of the heating layer can take place with all known procedures.

The invention is explained with the example of a conventional adhesive foil with heating cables.

The known production of resistance heating from a laminated copper foil in a photo etching process resulted in a flexible foil, which is subsequently attached with double-sided tape on the rear side of the mirror. In the process, the heating cables comprise the same distances, thicknesses and widths, so that the applied voltage results in a current flow, which is as equal as possible.

Advantageous configurations of the invention are the items of the subclaims.

A possible execution example of the invention is shown in the drawings, and is subsequently explained in more detail. In the drawings:

### BRIEF DESCRIPTION OF THE DRAWINGS

FIG. 1 shows a heating foil in the prior art

FIG. 2 shows a heating foil according to the invention in a top view

FIG. 3 shows a second design according to the invention

FIG. 4 shows a coated embodiment

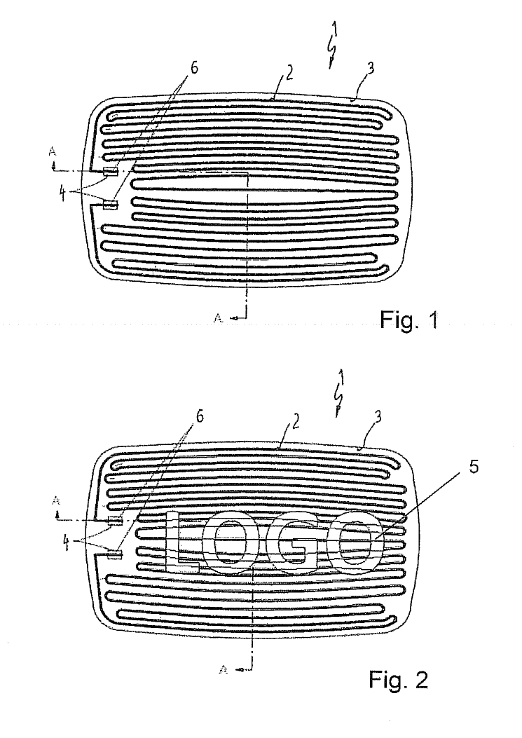

### DETAILED DESCRIPTION OF THE DRAWINGS

A backing plate 1 for a minor, not shown in more detail, particularly an exterior mirror for a motor vehicle, comprises a surface 3 on the front side, turned towards a mirror glass, not shown. The surface 3 is part of the heating device and is provided with a meandering conducting path 2. The surface 3 describes a first region of the backing plate without foil, which is heated. The ends 6 of the conducting path 2 are led through on one side of the surface 3, and soldered with angular contacts 4.

The backing plate 1 consists of a plastic material and is stamped from a film, or is produced in an injection moulding process, in another design. All types of plastic, which can be manipulated in an injection moulding process, are suitable as material for the backing plate 1.

The conducting path 2 is sprayed on meandering in a variety of loops on the front side of the surface 3. The available surface of the backing plate 1 plays a role, inter alia, in selection of resistance materials. In order to achieve a heater current of 2 amps, in vehicle voltage of 12 volts, and thus an electrical output of 24 watts, a cross-sectional surface of the conducting path 2 of 0, 2 mm², and a desired resistance of 6 Ohm, is taken as the starting point.

The heating device (conducting path 2) and its heating output are measured in such a way that a quick and equal thawing of the mirror from condensation and/or ice is achieved.

As shown in FIG. 2, the heating device is modified in such a way that during defrosting of the mirror, a logo appears in the region 5. The second region 5 includes the surface, which is formed by the letters or signs of a logo. For this purpose, the cross-sectional surfaces of the heating cables 3 are reduced by a length, which corresponds to the diameter of the logo. The resistance, and thus the heating current, also increase locally due to the tapering of the cross-section. Through this, a higher heating output is achieved locally in the region of the dimensions of the logo. The mirror to be defrosted is therefore defrosted first of all in the region of the logo, with the structure appearing whilst the rest of the mirror is still iced over or misted. The whole mirror is mist-free within the time desired by the manufacturer.

Alternatively, the application can be in inverse form, in which the region of the logo receives less heating output, and therefore remains as an iced over or misted structure, before it defrosts in the nominal time frame.

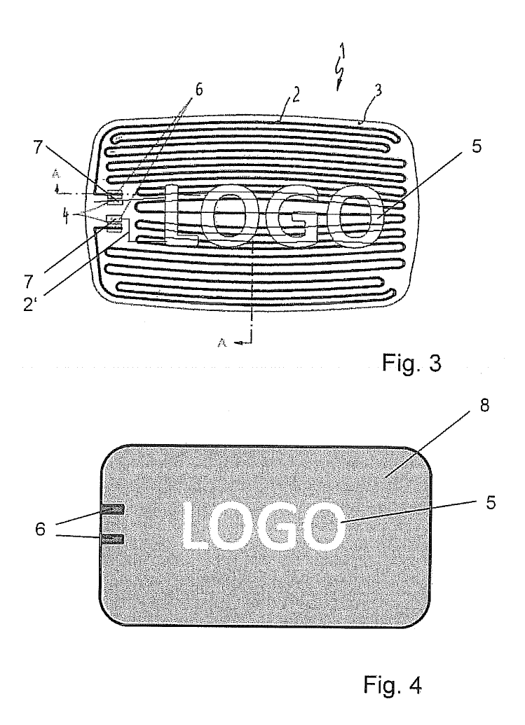

Differing from the execution example shown, two or several separate heating circuits with conducting paths 2, 2′ and contacts 4 and 7, electrically separated from each other, can be provided, as shown in FIG. 3. In this embodiment, the targeted separate control of two regions in this heating unit. The layout of two separate heating circuits simplifies the layout of the whole heating element. No transitions need to be provided between different cross-sections of the heating conductor. The risk of burn-out is reduced.

A further embodiment is achieved with the use of two separate heating circuits. The heating wires of a heating circuit are positioned in the process along the contour of a logo or sign. The logo is thus directly defrosted. Above all, this embodiment is suitable for logos which do not have radii which are too narrow, so that the current flow must not be led through these narrow radii in the heating conductor.

A solution is also possible with two separate heating circuits, which control a heating circuit, first of all, and the second heating circuit with a time delay. With this timed solution, total defrosting is achieved in the desired frame, and the layout of the heating circuit is optimised. The time delay is effected by a switching mechanism with a timing relay.

The heating circuit can also be controlled by a thermistor. If the first section of the mirror and thus the thermistor warms up, it connects the second heating circuit for this purpose. Therefore a temperature-controlled, timed solution is given for both heating zones. For this solution, the circuit of the heating installation is to be attached on the surface to be heated, since the surface temperature controls the thermistor.

FIG. 4 shows an embodiment, which works with a flat coating for heating a mirror. The region 5 of the logo is exempt from the coating. The rest of the coating must be laid out so that despite the recesses, a homogenous current flow is guaranteed, and the omitted surfaces are equally defrosted by heat conduction within the desired time frame.

If a flat coating is chosen, a structuring e.g. in meandering heat conductors with a laser, is possible. The structuring with a laser also facilitates the simplified entry of a logo in the conductive layer. Through the choice of the laser output, together with the writing speed, allows a part removal of the conductive layer in the region of the logo to be achieved, so that in this region more heating occurs due to the higher resistance.

Alternatively, the application of the heating conductors can take place with different spraying processes.

In an arc spraying process, an arc between two filamentary spraying additions of the same or different compositions is used in order to melt the wire tips. The melted material is sprayed with one or several gas jets, mostly compressed air, and propelled onto the prepared surface of the intermediate layer.

The inert gas arc spraying process can be used to improve the qualities of the coated resistance path. In this process, lower porosity and reduced oxidation is achieved in the layer of the coated resistance material. Entry of air in the hot gas and particle flow is prevented by a second gas flow in a protective body or by a mantle of protective gas around the arc and the spray jet. The speed of the spray jet can also be increased, in order to increase the thickness of the resistance material. Through this, the contact time of the particles of the resistance material with the sprayer and protective gas is reduced.

Ferrous metals, non-ferrous metals, conductive plastics, cermet coatings (sintered ceramic metals) etc, can be used as resistance material. Special alloys with correspondingly selected specific ohmic resistance can also be used.

The application of the resistance material can take place continually along the desired course of the conducting path. In a preferred design of the invention, for speeding up the application of material, a mask is used, which covers those regions of the surface 3, on which no resistance material should be applied, so that the application of the resistance material can take place in two dimensions.

As well as the application of the resistance material of the conducting path, the periphery of the heating device can be sprayed in a thermal spraying process. Here this can concern the power supply for the conducting path, which is formed by a highly conductive material. Similarly, insulating materials can be applied with a thermal spraying process.

The electrical insulation of the heating device relative to the reflective layer of the minor glass is done by an adhesive or an insulating varnish. The adhesive or insulating varnish here has a double function, namely, the electrical insulation on one hand, and the connection of the mirror glass with the heating element on the other hand. The reflective layer of the mirror glass, which is sensitive to mechanical strain and enviromnental influences, is protected by the adhesive or the insulating varnish.

The term ‘mirror glass’ is used in connection with the present invention not only for mineral glass, but also for all possible transparent substrates, for example, of thermoplastic or thermosetting materials.

The solution according to the invention is not limited to representing logos. Any type of note or sign can be shown.

1. (canceled)

2. An exterior rear view mirror assembly according to claim 14, wherein each of said first and second regions of said heating device includes heating cables with different resistance.

3. An exterior rear view mirror assembly according to claim 14, 1, wherein each of said first and second regions of said heating device includes heating cables with different cross-sections.

4. An exterior rear view mirror assembly according to claim 14, wherein said heating cables of said first and second regions are provided with power by a contact pair.

5. An exterior rear view mirror assembly according to claim 14, wherein said heating cables of said first and second regions are provided with power by several contact pairs.

6. An exterior rear view mirror assembly according to claim 14, wherein said heating cables of said first and second regions are provided with power with a time lag.

7. An exterior rear view mirror assembly according to claim 6, wherein the time lag is effected by a timing element in the heating circuit.

8. An exterior rear view mirror assembly according to claim 6, wherein the time lag is effected by using a thermistor in the heating circuit.

9. (canceled)

10. An exterior rear view mirror assembly according to claim 14, wherein the one of the first and second regions that has precipitation removed first includes said sign.

11. An exterior rear view mirror assembly according to claim 14, wherein the one of the first and second regions that has precipitation removed last includes said sign.

12. (canceled)

13. An exterior rear view mirror assembly for a motor vehicle having a power supply, said exterior rear view mirror assembly comprising:
a mirror bracket secured to the motor vehicle;
a mirror housing secured to said mirror bracket, said mirror housing defining a primary opening facing rearward;
a substrate movably secured within said mirror housing;
a mirror fixedly secured to said substrate and movable therewith; and
a heating device having a heatable element disposed between said substrate and said mirror, said heating device having contact with the mirror, whereby said heatable element is electrically connected to electrical contacts of the power supply, wherein said heating device is divided into first and second regions, and said first and second regions are subjected to different heating output or different heat release over time.

14. An exterior rear view mirror assembly as set forth in claim 13 including a sign disposed in said second region and becomes visible when said heating device removes any precipitation on said mirror.

15. An exterior rear view mirror assembly as set forth in claim 14 wherein said heating device is flat.
